(19) United States
(12) Patent Application Publication
(10) Pub. No.: US 2017/0195560 A1
(43) Pub. Date: Jul. 6, 2017

(54) METHOD AND APPARATUS FOR GENERATING A PANORAMIC VIEW WITH REGIONS OF DIFFERENT DIMENSIONALITY

(71) Applicant: Nokia Technologies Oy, Espoo (FI)

(72) Inventors: Muninder Veldandi, San Jose, CA (US); Basavaraja Shanthappa Vandrotti, Sunnyvale, CA (US)

(21) Appl. No.: 14/985,838

(22) Filed: Dec. 31, 2015

(51) Int. Cl. H04N 5/232; H04N 7/18; G06T 7/00

(52) U.S. Cl. CPC H04N 5/23238; G06T 7/0065; H04N 7/181

(57) ABSTRACT

A method, apparatus and computer program product are provided to generate a panoramic view in a computationally efficient manner. In regards to a method, images captured by at least three cameras are received. Each camera has a different, but partially overlapping field of view. The method generates first and second panoramic views. The first and second panoramic views include a first region generated such that pixels are based upon an image captured by one camera. The first and second panoramic views also include a second region that at least partially corresponds with the mutually overlapping portion of the fields of view. The generation of the second region is based upon a combination of images captured by at least two of the cameras and includes combining the images captured by at least two of the cameras utilizing depth information associated with an image captured by at least one of the cameras.

### TECHNICAL FIELD

An example embodiment relates generally to the generation of a panoramic view based on images captured by a plurality of cameras.

### BACKGROUND

Panoramic views are generated for a variety of purposes. For example, panoramic views may be utilized in conjunction with various virtual reality applications. In such a virtual reality system, a viewer, such as a person with viewing a head mounted display, may focus on different portions of the panoramic view including a central portion positioned in front of the viewer as well as peripheral portions positioned to the sides of the viewer. As such, the viewer may be more fully immersed in the scene represented by the panoramic view.

A panoramic view may be captured by a plurality of cameras with the images captured by the cameras then stitched and blended together. The combination of the images to form the panoramic image may be both processing intensive and time intensive. For example, the Google Jump system utilizes 16 cameras to capture a 360° panoramic view as well as the associated audio. The Google Jump system then utilizes offline processing to combine the images captured by the plurality of cameras. As such, the availability of the resulting panoramic view is delayed by the requisite processing of the images such that the panoramic image cannot be viewed in real time. Other systems are available or have been proposed for the capture of content from which a panoramic view suitable for virtual reality purposes can be constructed. However, these other systems also generally require fairly extensive image processing in order to combine and blend the images captured by a plurality of cameras, thereby limiting the utilization of such systems.

### BRIEF SUMMARY

A method, apparatus and computer program product are therefore provided in accordance with an example embodiment in order to generate a panoramic view, such as for utilization in conjunction with a virtual reality system, in a computationally efficient manner. In this regard, the method, apparatus and computer program product of an example embodiment provide for the generation of the panoramic view in a more timely manner and with less intensive processing than at least some conventional systems. Thus, the resulting panoramic view may be more readily available and may be more widely utilized, such as by viewers of virtual reality systems.

In an example embodiment, a method is provided that includes receiving images captured by at least three cameras having different fields of view. The different fields of view have a mutually overlapping portion. The method of this example embodiment also includes generating a first panoramic view and a second panoramic view, different than the first panoramic view. The first and second panoramic views are generated by generating a first region of a respective panoramic view such that pixels within the first region are based upon an image captured by one camera of the at least three cameras. The first and second panoramic views are also generated by generating a second region of the respective panoramic view at least partially corresponding with the mutually overlapping portion of the fields of view. The generation of the second region of a respective panoramic view is based upon a combination of images captured by at least two cameras of the at least three cameras. The generation of the second region of the respective panoramic view includes combining the images captured by at least two cameras of the at least three cameras utilizing depth information associated with an image captured by at least one camera of the at least three cameras, such as by utilizing depth based blending.

The method of an example embodiment generates the first region of a respective panoramic view by generating the first region of the first panoramic view such that all pixels within the first region are based upon an image captured by the one camera. A method of an example embodiment also generates the first region of a respective panoramic view by generating the first region of the second panoramic view so as to have a first subregion comprised of pixels that are based upon the image captured by the first camera and a second subregion comprised of pixels that are based upon the image captured by the second camera. The method of an example embodiment generates the first panoramic view and the second panoramic view by generating, for the panoramic views, a third region of the respective panoramic view such that pixels within the third region are based upon the image captured by the one camera. In this example embodiment, the second region is positioned between the first and third regions of the respective panoramic image.

The method of an example embodiment also includes causing the first and second panoramic views to be presented to left and right eyes, respectively, such that the first region of the respective panoramic views is presented in two dimensions and the second region of the respective panoramic views is presented in three dimensions. In an example embodiment, the at least three cameras includes first, second and third cameras having different, but partially overlapping fields of view. The method of this example embodiment generates the second region of the respective panoramic view by generating the second region of the first panoramic view based upon a combination of the images captured by the first and second cameras and generating the second region of the second panoramic view based upon a combination of the images captured by the second and third cameras.

In another example embodiment, an apparatus is provided that includes at least one processor and at least one memory that includes computer program code with the at least one memory and the computer program code configured to, with the at least one processor, cause the apparatus to at least receive images captured by at least three cameras having different fields of view. The different fields of view have a mutually overlapping portion. The at least one memory and computer program code are also configured to, with the at least one processor, cause the apparatus to generate a first panoramic view and a second panoramic view, different than the first panoramic view. The first and second panoramic views are generated by generating a first region of a respective panoramic view such that pixels within the first region are based upon an image captured by one camera of the at least three cameras and generating a second region of the respective panoramic view at least partially corresponding with the mutually overlapping portion of the fields of view. The generation of the second region of the respective panoramic view is based upon a combination of images captured by at least two cameras of the at least three cameras. The generation of the second region of the respective panoramic view includes combining the images captured by at least two cameras of the at least three cameras utilizing depth information associated with an image captured by at least one camera of the at least three cameras, such as by utilizing depth based blending.

The at least one memory and the computer program code are configured to, with the at least one processor, cause the apparatus of an example embodiment to generate the first region of a respective panoramic view by generating the first region of the first panoramic view such that all pixels within the first region are based upon an image captured by the one camera. The at least one memory and the computer program code are configured to, with the at least one processor, cause the apparatus of an example embodiment to generate the first region of the respective panoramic view by generating the first region of the second panoramic view so as to have a first subregion that includes pixels that are based upon the image captured by a first camera and a second subregion that includes pixels that are based upon the image captured by a second camera. The at least one memory and the computer program code are configured to, with the at least one processor, cause the apparatus of an example embodiment to generate the first panoramic view and the second panoramic view by generating, for the panoramic views, a third region of the respective panoramic views such that pixels within the third region are based upon the image captured by the one camera. In this example embodiment, the second region is positioned between the first and third regions of the respective panoramic image.

The at least one memory and the computer program code are further configured to, with the at least one processor, cause the apparatus of an example embodiment to cause the first and second panoramic views to be presented to left and right eyes, respectively. Thus, the first region of the respective panoramic views is presented in two-dimensions and the second region of the respective panoramic views is presented in three-dimensions. In an example embodiment, the at least three cameras include first, second and third cameras having different, but partially overlapping fields of view. The at least one memory and the computer program code are configured to, with the at least one processor, cause the apparatus of this example embodiment to generate the second region of the respective panoramic view by generating the second region of the first panoramic view based upon a combination of the images captured by the first and second cameras and by generating the second region of the second panoramic view based upon a combination of the images captured by the second and third cameras.

In a further example embodiment, a computer program product is provided that includes at least one non-transitory computer-readable storage medium having computer-executable program code instructions stored therein with the computer-executable program code instructions including program code instructions configured to receive images captured by at least three cameras having different fields of view. The different fields of view have a mutually overlapping portion. The computer-executable program code instructions also include program code instructions configured to generate a first panoramic view and a second panoramic view, different than the first panoramic view. The first and second panoramic views are generated by generating a first region of a respective panoramic view such that pixels within the first region are based upon an image captured by one camera of the at least three cameras. The first and second panoramic views are also generated by generating a second region of the respective panoramic view at least partially corresponding with the mutually overlapping portion of the fields of view. The generation of the second region of the respective panoramic view is based upon a combination of images captured by at least two cameras of the at least three cameras. The generation of the second region of the respective panoramic view includes combining the images captured by at least two cameras of the at least three cameras utilizing depth information associated with an image captured by at least one camera of the at least three cameras, such as by utilizing depth based blending.

In an example embodiment, the program code instructions configured to generate the first region of a respective panoramic view include program code instructions configured to generate the first region of the first panoramic view such that all pixels within the first region are based upon an image captured by the one camera. The program code instructions configured to generate the first region of a respective panoramic view also include, in this example embodiment, program code instructions configured to generate the first region of the second panoramic view so as to have a first subregion comprised of pixels that are based upon the image captured by a first camera and a second subregion comprised of pixels that are based upon the image captured by a second camera. In an example embodiment, the program code instructions configured to generate the first panoramic view and the second panoramic view include program code instructions configured to generate, for the panoramic views, a third region of the respective panoramic view such that pixels within the third region are based upon the image captured by the one camera. The second region of this example embodiment is positioned between the first and third regions of the respective panoramic image.

The computer-executable program code instructions of an example embodiment further include program code instructions configured to cause the first and second panoramic views to be presented to left and right eyes, respectively, such that the first region of the respective panoramic views is presented in two-dimensions and the second region of the respective panoramic views is presented in three-dimensions. In an example embodiment, the at least three cameras include first, second and third cameras having different, but partially overlapping fields of view. The program code instructions of this example embodiment that are configured to generate the second region of the respective panoramic view include program code instructions configured to generate the second region of the first panoramic view based upon a combination of the images captured by the first and second cameras and program code instructions configured to generate the second region of the second panoramic view based upon a combination of the images captured by the second and third cameras.

In yet another example embodiment, an apparatus is provided that includes means for receiving images captured by at least three cameras having different fields of view. The different fields of view have a mutually overlapping portion. The apparatus of this example embodiment also includes means for generating a first panoramic view and a second panoramic view, different than the first panoramic view. The first and second panoramic views are generated by generating a first region of a respective panoramic view such that pixels within the first region are based upon an image captured by one camera of the at least three cameras. The first and second panoramic views are also generated by generating a second region of the respective panoramic view at least partially corresponding with the mutually overlapping portion of the fields of view. The generation of the second region of the respective panoramic view is based upon a combination of images captured by at least two cameras of the at least three cameras. The generation of the second region of the respective panoramic view includes combining the images captured by at least two cameras of the at least three cameras utilizing depth information associated with an image captured by at least one camera of the at least three cameras.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 depicts the respective fields of view of first, second and third cameras configured to capture images that are processed in accordance with an example embodiment of the present invention;

FIG. 2 is a block diagram of an apparatus that may be specifically configured in accordance with an example embodiment of the present invention;

FIG. 3 is a flowchart illustrating the operations performed, such as by the apparatus of FIG. 2, in accordance with an example embodiment of the present invention;

FIG. 4 is a representation of the different regions of the first and second panoramic views that are generated in accordance with an example embodiment of the present invention; and

FIG. 5 is a flowchart illustrating the operations performed, such as by the apparatus of FIG. 2, in order to generate the first region of the first and second panoramic views in accordance with an example embodiment of the present invention.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment in order to efficiently generate a panoramic view, such as for use in conjunction with virtual reality or other applications. In this regard, a panoramic view is generated that includes a region, such as the region that is positioned in front of the viewer, that is presented in thee-dimensions (3D) and other regions, such as peripheral regions, that are presented in two-dimensions (2D). By judiciously generating the panoramic view so as to include both 3D regions and 2D regions, the panoramic view may be generated in an efficient manner, both in terms of the processing resources consumed during the generation of the panoramic view and the time required to generate the panoramic view. Thus, the panoramic view may, in some instances, be generated in real time or near real time relative to the capture of the images that at least partially comprise the panoramic view.

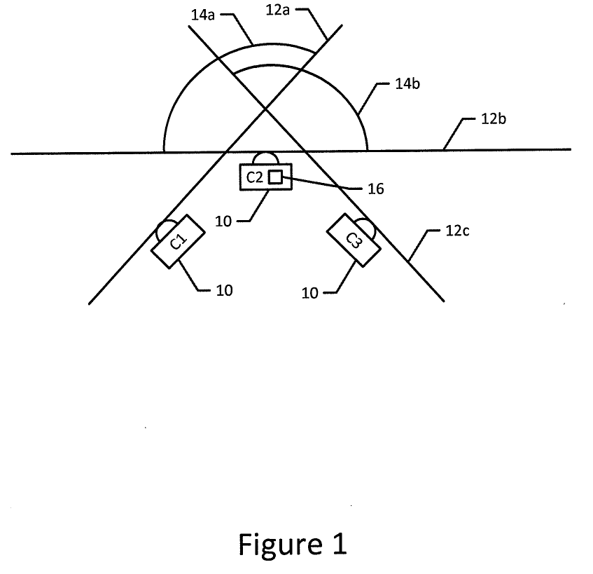

The panoramic view that is generated in accordance with an example embodiment of the present invention is based upon images captured by at least three cameras. In the embodiment depicted in FIG. 1, the three cameras 10 include a first camera C1, a second camera C2 and a third camera C3. However, in other embodiments, images may be captured by more than three cameras, such as four or more cameras, and then combined as described herein to generate a panoramic image. A variety of different types of cameras having different fields of view may be utilized in order to capture the images that are utilized to generate the panoramic view. In the embodiment described herein, however, each of the cameras is a fisheye camera having a 180° field of view. Moreover, while each of the cameras may be the same type of camera and may have a field of view that extends over the same angular range, such as 180°, the cameras may differ from one another and may have different fields of view in other embodiments.

As shown in FIG. 1, the cameras 10 are positioned so as to have different fields of view. However, the fields of view of the at least three cameras have a mutually overlapping portion. In the embodiment illustrated in FIG. 1, for example, the first camera C1 has a 180° field of view as represented by line 12a. Similarly, the second camera C2 and the third camera C3 have 180° fields of view as represented by lines 12b and 12c, respectively. As shown in the embodiment of FIG. 1, the fields of view of each of the cameras differ from one another, but share a mutually overlapping portion. In this regard, the fields of view of the first and second cameras overlap in the region designated 14a in FIG. 1, while the fields of view of the second and third cameras overlap in a region designated 14b in FIG. 1. Further, the fields of view of all three cameras of the embodiment of FIG. 1 overlap in the central region defined by the intersection of regions 14a and 14b.

As shown in the embodiment depicted in FIG. 1, the cameras 10 may be arranged in a symmetrical relationship such that the first camera C1 and the third camera C3 are disposed at the same angle and spaced by the same distance from the second camera. For example, the first camera C1 may be oriented at an angle of −45° relative to the second camera C2 and the third camera C3 may be oriented at an angle of +45° relative to the second camera C2. Moreover, the cameras of the illustrated embodiment are mounted in a plane, such as a horizontal plane such that each of the cameras is located the same vertical distance from ground. However, the cameras may be differently positioned and oriented in other embodiments.

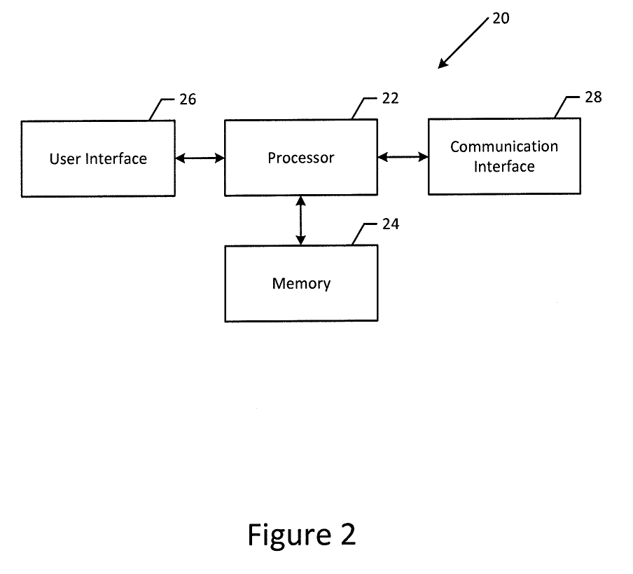

Based upon the images captured by the cameras 10, a panoramic view is generated. In this regard, the panoramic view may be generated by an apparatus 20 as depicted in FIG. 2. The apparatus may be embodied by one of the cameras or may be distributed between the cameras. Alternatively, the apparatus may be embodied by another computing device, external from the cameras. For example, the apparatus may be embodied by a personal computer, a computer workstation, a server or the like, or by any of various mobile computing devices, such as a mobile terminal, e.g., a smartphone, a tablet computer, a video game player, etc. Alternatively, the apparatus may be embodied by a virtual reality system, such as a head mounted display.

Regardless of the manner in which the apparatus 20 is embodied, the apparatus of an example embodiment is configured to include or otherwise be in communication with a processor 22 and a memory device 24 and optionally the user interface 26 and/or a communication interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the apparatus 20 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the apparatus 20 may optionally include a user interface 26 that may, in turn, be in communication with the processor 22 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory device 24, and/or the like).

The apparatus 20 may optionally also include the communication interface 28. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms

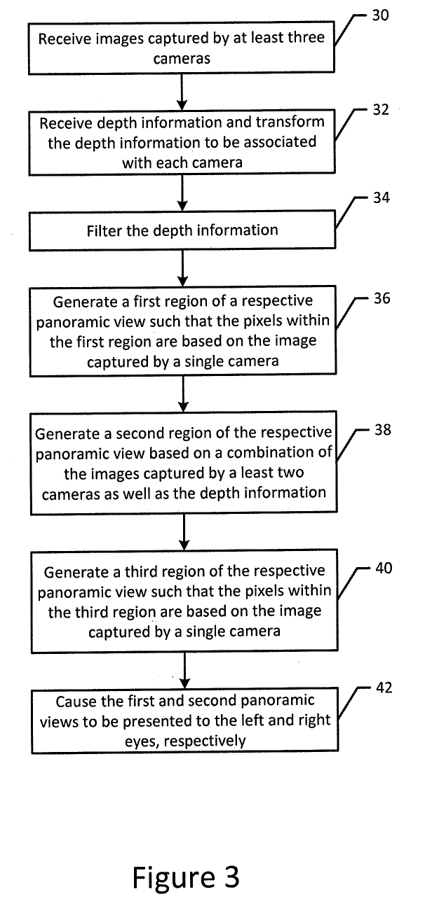

Referring now to FIG. 3, the operations performed by the apparatus 20 of FIG. 2 in accordance with an example embodiment to the present invention are depicted. In this regard, the apparatus includes means, such as the processor 22, the memory 24, the communication interface 28 or the like, for receiving images captured by the at least three cameras 10. As described above, each camera has a different field of view and the fields of view of the at least three cameras have a mutually overlapping portion. The images captured by the cameras may be received by the apparatus directly from the cameras, such as via the communication interface. Alternatively, the images captured by the cameras may be stored, such as in the memory 24 or in an external memory, and may thereafter be received by the apparatus following storage.

The apparatus 20 of an example embodiment also includes means, such as the processor 22, the memory 24, the communication interface 28 or the like, for receiving depth information associated with the image captured by at least one of the cameras 10. In this regard, the multi-camera system depicted in FIG. 1 may also include a depth sensor 16. While various types of depth sensors may be utilized, one example of a depth sensor is the depth sensor utilized by the Intel® RealSense™ sensor. Other examples of a depth sensor include an infrared (IR) camera and a time of flight (TOF) camera. As shown in FIG. 1, the depth sensor may be associated with and, in one embodiment, may be co-located with one of the cameras, such as the second camera C2. However, the depth sensor may be separate from the cameras, but still configured to determine the depth information associated with an image captured by at least one of the cameras.

Based upon extrinsic camera matrix information that define the manner in which the cameras are positioned and oriented relative to one another, the apparatus, such as the processor, is configured to transform the depth information associated with the image captured by one of the cameras to the images captured by the other cameras. In an example embodiment, the depth information may be represented by a depth map (also known as a diversity map) in which each element of the depth map is associated with a corresponding pixel or group of pixels of the image captured by the respective camera and provides information regarding the distance from the respective camera to the feature represented by the pixel or group of pixels. The depth information associated with the image captured by one of the cameras may then be transformed so as to be associated with the images captured by the other cameras The depth information may be transformed based upon extrinsic camera matrix information that defines the manner in which the cameras are oriented relative to one another. The extrinsic camera matrix information may be stored by the memory 24 or may otherwise be accessible to the processor 22. Based upon the extrinsic camera matrix information, the apparatus 20, such as the processor, may transform the depth map associated with the image captured by one of the cameras to depth maps associated with the images captured by the other cameras, such as described by OpenCV 2.4.12.0 documentation entitled “Camera Calibration and 3D Reconstruction”. Prior to or following the transformation of the depth information associated with the image captured by one of the cameras to the images captured by the other cameras, the apparatus, such as the processor, may be configured to filter the depth map so as to fill any holes within the depth map and/or to fill or replace any regions within the depth map for which there is a relatively low confidence in the corresponding depth information. See block 34 of FIG. 3.

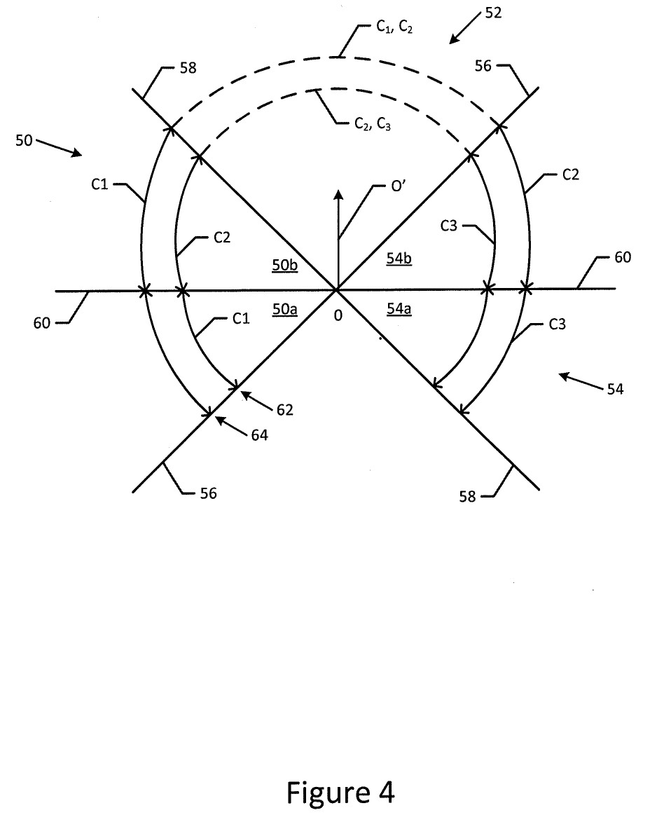

The apparatus 20 also includes means, such as the processor 22 or the like, for generating a first panoramic view and a second panoramic view, different than the first panoramic view. As described below, the first and second panoramic views may subsequently be separately presented to the left and right eyes, respectively, of a viewer in order to provide for a stereoscopic display. In order to generate the first and second panoramic views, the apparatus of an example embodiment includes means, such as a processor or the like, for generating a first region of a respective panoramic view such that the pixels within the first region, such as each pixel within the first region, are based upon the image captured by one camera 10. See block 36 of FIG. 3. In order to illustrate the images of the various cameras that are utilized to form the different regions of the respective panoramic views, reference is now made to FIG. 4. In FIG. 4, the viewer is considered to be located at a central point O and to be facing forwardly in a direction designated O′. As described below, a first panoramic view designated 62 is presented to the left eye of the viewer, while a second panoramic view designated 64 is concurrently presented to the right eye of the viewer. As shown in FIG. 4, different regions of the panoramic view located at different angular positions relative to the direction in which the viewer is facing may be formed of different image(s) captured by the camera(s).

Based upon the images captured by the cameras 10 and the respective fields of view of the cameras, the angular extent of the panoramic view that is generated is generally divided into three regions, namely, a first region 50 positioned to the left of the viewer, a second region 52 positioned generally in front of the viewer in the direction which the viewer is facing and a third region 54 positioned to the right of the viewer, as shown in FIG. 4. The first and third regions therefore generally lie within the peripheral vision of the viewer when the viewer is facing forward in the direction designated O′, while the second region is generally in the line of sight of the viewer (unless the viewer sharply turns their head). Based upon the positioning and the orientation of the cameras of FIG. 1, the first, second and third regions of the panoramic views that are generated in accordance with the embodiment of FIG. 4 are each of the same size, that is, 90°, so as to define a 270° panoramic view. However, different positioning and orientation of the cameras may correspondingly alter the angular extent of the panoramic view, such as by causing a panoramic view to be generated that has an angular range that is greater or less than 270°, and may also alter the size of the different regions of the panoramic view, such that the regions no longer all have the same size.

For example, the first camera C1 and the third camera C3 may be oriented at a greater angular difference relative to the second camera C2, such as that +/−60° relative to the second camera C2. In this embodiment, the angular extent of the panoramic view would be increased, but the angular extent of the second region 52 of the panoramic view (in which the fields of view of all of the cameras 10 overlap) that is presented in three-dimensions as described below would be decreased and the angular extent of the first region 50 and the third region 52 that are presented in two-dimensions as described below would be increased. Conversely, the first camera C1 and the third camera C3 may be oriented at a smaller angular difference relative to the second camera C2, such as that +/−30° relative to the second camera C2. In this embodiment, the angular extent of the panoramic view would be decreased, but the angular extent of the second region 52 of the panoramic view (in which the fields of view of all of the cameras 10 overlap) that is presented in three-dimensions as described below would be increased and the angular extent of the first region 50 and the third region 52 that are presented in two-dimensions as described below would be decreased.

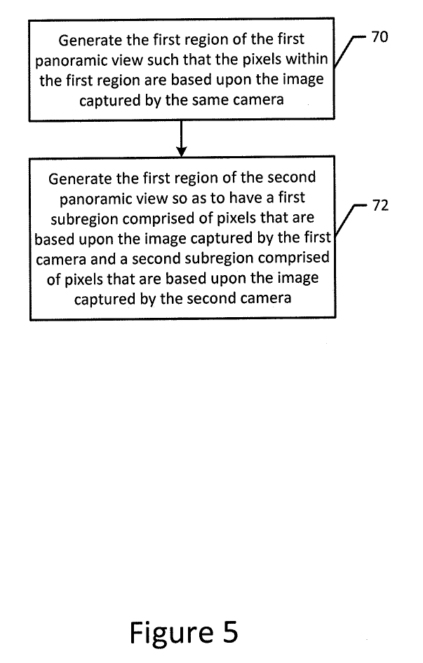

With respect to the generation of the first region 50 of a respective panoramic view, FIG. 5 depicts the operations performed by the apparatus 20 in accordance with an example embodiment. In this embodiment, the apparatus includes means, such as the processor 22 or the like, for generating the first region 50 of the first panoramic view 62 such that the pixels within the first region, such as all pixels within the first region, are based upon the image captured by the same camera. See block 70 of FIG. 5. As shown in FIG. 4, the entire angular extent of the first region of the first panoramic view is based solely upon the image captured by the first camera C1. In this example embodiment, the apparatus also includes means, such as the processor or the like, for generating the first region 50 of the second panoramic view 64 so as to have a first subregion 50a comprised of pixels that are based upon the image captured by the first camera C1 and a second subregion 50b comprised of pixels that are based upon the image captured by the second camera C2. See block 72 of FIG. 5. As shown in FIG. 4, for example, the first region of the second panoramic view is divided, such as by the line 60 representing the field of view of the second camera C2, into a first subregion 50a in which only the image captured by the first camera C1 is utilized and a second subregion 50b in which only the image captured by the second camera C2 is utilized. Due to the symmetry of the orientation and positions of the cameras 10, the first and second subregions are of equal angular size in the embodiment of FIG. 4. However, the subregions may have different sizes in an embodiment in which the cameras are not symmetrically oriented and positioned.

As shown in block 38 of FIG. 3, the apparatus 20 also includes means, such as the processor 22 or the like, for generating a second region 52 of the respective panoramic view that at least partially corresponds to the mutually overlapping portion of the fields of view of the at least three cameras 10. In an example embodiment, the second region 52 fully corresponds with the mutually overlapping portions of the fields of view of the at least three cameras so as to be defined as the central region between the lines 12a and 12c representative of the fields of view of the first camera C1 and the third camera C3 (and correspondingly represented by lines 56 and 58 in FIG. 4). As such, in this example embodiment, the first region 50 of the panoramic views is located counterclockwise from the second region so as to be defined as the left region between the lines 12a and 12c in FIG. 1 (and similarly between lines 56 and 58 in FIG. 4. Unlike the first region 50 of the respective panoramic views in which each pixel is based upon the image captured by one camera, the second region 52 of the respective panoramic views is generated based upon a combination of the images captured by at least two of the cameras. Further, the second region of the respective panoramic views is generated by combining the images captured by at least two of the cameras utilizing depth information associated with the image captured by at least one of the cameras. In contrast, the first region 50 of the respective panoramic views is not generated in a manner that utilizes depth information associated with the images captured by the cameras.

By way of example, in the embodiment depicted in FIG. 4, the second region 52 of the first panoramic view 62 is generated based upon a combination of the image captured by the first camera C1 and the image captured by the second camera C2. Additionally, the second region 52 of the second panoramic view 64 is generated based upon a combination of the image captured by the second camera C2 and the image captured by the third camera C3. As described below, in combining the images captured by the pairs of cameras, the depth information is utilized. Although the images may be combined within the second region 52 of the respective panoramic views in various manners, the apparatus 20, such as the processor 22, of an example embodiment is configured to combine the images captured by the first camera C1 and the second camera C2 to generate the first panoramic view within the second region 52 Lₒᵥₑᵣₗₐₚ as follows:

Lₒᵥₑᵣₗₐₚ(x,y)=c₁(x,y)*w₁(x,y)+c₂(x′,y′)*(1−w₁(x,y))

wherein x and y are the coordinates of the respective pixels within an image. In addition, c₁(x,y) is the value of a pixel at location x, y within the image captured by camera I and w₁(x,y) represents the blending weight which may be set to a predefined value, such as 0.5. Additionally, (x′,y′) represent the pixel location within the image captured by another camera, such as camera C2, that corresponds to location (x,y) within the image captured by a first camera C1.

As noted above, the images from two or more cameras are combined in a manner that utilizes the depth information, such as by utilizing depth based blending in which the images are warped and/or aligned utilizing the depth information, e.g., depth maps. As such, in an embodiment in which the images captured by the first camera C1 and the second camera C2 are calibrated and rectified and lie in a horizontal plane, the apparatus 20, such as the processor 22, may be configured to take into account the depth information in determining the corresponding pixel location (x′,y′) within the image captured by the second camera C2 as follows:

x′=x+k*d1(x,y)

y′=y

wherein k is a predefined constant, such as an integer constant, and d1(x,y) is the depth of the pixel at location (x,y) within the image captured by the first camera C1.

As such, in a general case, the apparatus 20, such as the processor 22, may be configured to determine the corresponding pixel location within the image captured by the second camera C2 as follows:

(x′,y′)=f(x,y,d1(x,y),R12,T12,A2)

wherein R12 and T12 are provided by the extrinsic camera matrix information and define a relative rotation and translation, respectively between the first and second cameras and A2 is the camera intrinsic matrix of the second camera C2.

Similarly, the apparatus 20, such as the processor 22, of this example embodiment is configured to determine the combination of the images captured by the second and third cameras in order to generate the second region 52 of the second panoramic view 64 as follows:

Lₒᵥₑᵣₗₐₚ(x,y)=c₂(x,y)*w₂(x,y)+c₃(x′,y′)*(1−w₂(x,y))

wherein the subscripts 2 and 3 reference parameters associated with the second camera C2 and the third camera C3, respectively.

As shown in block 40 of FIG. 3, the apparatus 20 of an example embodiment includes means, such as the processor 22 or the like, for generating, for the first and second panoramic views, a third region 54 of the respective panoramic views such that the pixels within the third region, such as each pixel within the third region, are based upon the image captured by one camera. As shown in FIG. 4 and as noted above, the second region 52 of the panoramic views may be positioned between the first region 50 and the third region 54 of the respective panoramic views. Although the third region of the respective panoramic views may be generated in various manners, the apparatus, such as the processor, of an example embodiment is configured to generate the third region of the respective panoramic views in a comparable manner to that described above in conjunction with the first region of the respective panoramic views.

In this regard and similar to that described above in conjunction with FIG. 5, the apparatus, such as the processor, of an example embodiment is configured to generate the third region 54 of the second panoramic view 64 such that all pixels within the third region are based upon the image captured by the same camera. As shown in FIG. 4, the entire angular extent of the first region of the second panoramic view is based solely upon the image captured by the third camera C3. In this example embodiment, the apparatus also includes means, such as the processor or the like, for generating the third region 54 of the first panoramic view 62 so as to have a first subregion 54a comprised of pixels that are based upon the image captured by the third camera C3 and a second subregion 54b comprised of pixels that are based upon the image captured by the second camera C2. As shown in FIG. 4, for example, the third region of the first panoramic view is divided, such as by the line 60 representing the field of view of the second camera C2, into a first subregion 54a in which only the image captured by the third camera C3 is utilized and a second subregion 54b in which only the image captured by the second camera C2 is utilized. As noted above, due to the symmetry of the orientation and positions of the cameras 10, the first and second subregions are of equal angular size in the embodiment of FIG. 4. However, the subregions may have different sizes in an embodiment in which the cameras are not symmetrically oriented and positioned.

Once each of the regions of the first and second panoramic views 62, 64 have been generated, the resulting panoramic views may be presented to the viewer, either immediately or following storage in memory 24 or a remote memory device. As such, the apparatus 20 of an example embodiment also includes means, such as the processor 22, the communication interface 28 or the like, for causing the first and second panoramic views to be presented to the left or right eyes, respectively, of a viewer. For example, the first and second panoramic views may be presented to the viewer utilizing various displays, such as a virtual reality display as may be embodied by a head mounted display, e.g., goggles. Based upon the manner in which the different regions of the first and second panoramic views are generated, the first region 50 and the third region 54 of the respective panoramic views are presented in two-dimensions, while the second region 52 of the respective panoramic views is presented in three-dimensions. Thus, the second region of the panoramic views that the viewer is generally facing (and which, therefore, is generally the focus of the viewer's attention) is presented in three dimensions so as to enhance the user experience, such as in conjunction with a virtual reality application or otherwise. However, the first and third regions positioned within the peripheral view of the viewer are presented in two-dimensions such that the viewer can see features within the first and third regions. As a result of the generation of the first and third regions of the panoramic views in two-dimensions, the generation of the first and third regions is performed with increased efficiency, both in terms of the computational efficiency and the time required for computation. Thus, the resulting panoramic views may be more readily available and may be more widely utilized, such as by viewers of virtual reality systems.

The method, apparatus 20 and computer program product of an example embodiment may generate first and second panoramic views of representative of a single image captured by each of the cameras 10. Alternatively, the method, apparatus and computer program product may generate first and second panoramic views of representative of each frame of the video images captured by each of the cameras 10. In this embodiment in which the panoramic views of each frame of a video image are generated, the efficiency improvements provided by example embodiments of the present invention may be magnified.

As described above, FIGS. 3 and 5 illustrate flowcharts of an apparatus 20, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 24 of an apparatus employing an embodiment of the present invention and executed by the processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving images captured by at least three cameras having different fields of view, wherein the different fields of view have a mutually overlapping portion; and
generating a first panoramic view and a second panoramic view, different than the first panoramic view, wherein the first and second panoramic views are generated by:
generating a first region of a respective panoramic view such that pixels within the first region are based upon an image captured by one camera of the at least three cameras; and
generating a second region of the respective panoramic view at least partially corresponding with the mutually overlapping portion, wherein generating the second region of the respective panoramic view is based upon a combination of images captured by at least two cameras of the at least three cameras, wherein generating the second region of the respective panoramic view comprises combining the images captured by at least two of the cameras utilizing depth information associated with an image captured by at least one camera of the at least three cameras.

2. A method according to claim 1 wherein generating the first region of a respective panoramic view comprises generating the first region of the first panoramic view such that all pixels within the first region are based upon an image captured by the one camera.

3. A method according to claim 1 wherein generating the first region of a respective panoramic view comprises generating the first region of the second panoramic view so as to have a first subregion comprised of pixels that are based upon the image captured by a first camera and a second subregion comprised of pixels that are based upon the image captured by a second camera.

4. A method according to claim 1 wherein generating the first panoramic view and the second panoramic view comprises generating, for the panoramic views, a third region of the respective panoramic view such that pixels within the third region are based upon the image captured by the one camera, wherein the second region is positioned between the first and third regions of the respective panoramic image.

5. A method according to claim 1 further comprising causing the first and second panoramic views to be presented to left and right eyes, respectively, such that the first region of the respective panoramic views is presented in two dimensions and the second region of the respective panoramic views is presented in three dimensions.

6. A method according to claim 1 wherein combining the images captured by at least two of the cameras comprises combining the images captured by at least two of the cameras utilizing depth based blending.

7. A method according to claim 1 wherein the at least three cameras comprise first, second and third cameras having different, but partially overlapping fields of view, and wherein generating the second region of the respective panoramic view comprises generating the second region of the first panoramic view based upon a combination of the images captured by the first and second cameras and generating the second region of the second panoramic view based upon a combination of the images captured by the second and third cameras.

8. An apparatus comprising at least one processor and at least one memory storing computer program code, the at least one memory and the computer program code configured to, with the processor, cause the apparatus to at least:
receive images captured by at least three cameras having different fields of view, wherein the different fields of view have a mutually overlapping portion; and
generate a first panoramic view and a second panoramic view, different than the first panoramic view, wherein the first and second panoramic views are generated by:
generating a first region of a respective panoramic view such that pixels within the first region are based upon an image captured by one camera of the at least three cameras; and
generating a second region of the respective panoramic view at least partially corresponding with the mutually overlapping portion, wherein generating the second region of the respective panoramic view is based upon a combination of images captured by at least two cameras of the at least three cameras, wherein generating the second region of the respective panoramic view comprises combining the images captured by at least two of the cameras utilizing depth information associated with an image captured by at least one camera of the at least three cameras.

9. An apparatus according to claim 8 wherein the at least one memory and the computer program code are configured to, with the processor, cause the apparatus to generate the first region of a respective panoramic view by generating the first region of the first panoramic view such that all pixels within the first region are based upon an image captured by the one camera.

10. An apparatus according to claim 8 wherein the at least one memory and the computer program code are configured to, with the processor, cause the apparatus to generate the first region of a respective panoramic view by generating the first region of the second panoramic view so as to have a first subregion comprised of pixels that are based upon the image captured by a first camera and a second subregion comprised of pixels that are based upon the image captured by a second camera.

11. An apparatus according to claim 8 wherein the at least one memory and the computer program code are configured to, with the processor, cause the apparatus to generate the first panoramic view and the second panoramic view by generating, for the panoramic views, a third region of the respective panoramic view such that pixels within the third region are based upon an image captured by the one camera, wherein the second region is positioned between the first and third regions of the respective panoramic image.

12. An apparatus according to claim 8 wherein the at least one memory and the computer program code are further configured to, with the processor, cause the apparatus to cause the first and second panoramic views to be presented to left and right eyes, respectively, such that the first region of the respective panoramic views is presented in two dimensions and the second region of the respective panoramic views is presented in three dimensions.

13. An apparatus according to claim 8 wherein the at least one memory and the computer program code are configured to, with the processor, cause the apparatus to combine the images captured by at least two of the cameras by combining the images captured by at least two of the cameras utilizing depth based blending.

14. An apparatus according to claim 8 wherein the at least three cameras comprise first, second and third cameras having different, but partially overlapping fields of view, and wherein the at least one memory and the computer program code are configured to, with the processor, cause the apparatus to generate the second region of the respective panoramic view by generating the second region of the first panoramic view based upon a combination of the images captured by the first and second cameras and generating the second region of the second panoramic view based upon a combination of the images captured by the second and third cameras.

15. A computer program product comprising at least one non-transitory computer-readable storage medium having computer-executable program code instructions stored therein, the computer-executable program code instructions comprising program code instructions configured to:
receive images captured by at least three cameras having different fields of view, wherein the different fields of view have a mutually overlapping portion; and
generate a first panoramic view and a second panoramic view, different than the first panoramic view, wherein the first and second panoramic views are generated by:
generating a first region of a respective panoramic view such that pixels within the first region are based upon an image captured by one camera of the at least three cameras; and
generating a second region of the respective panoramic view at least partially corresponding with the mutually overlapping portion of the fields of view, wherein generating the second region of the respective panoramic view is based upon a combination of images captured by at least two cameras of the at least three cameras, wherein generating the second region of the respective panoramic view comprises combining the images captured by at least two of the cameras utilizing depth information associated with an image captured by at least one camera of the at least three cameras.

16. A computer program product according to claim 15 wherein the program code instructions configured to generate the first region of a respective panoramic view comprise program code instructions configured to:
generate the first region of the first panoramic view such that all pixels within the first region are based upon an image captured by the one camera; and
generate the first region of the second panoramic view so as to have a first subregion comprised of pixels that are based upon the image captured by a first camera and a second subregion comprised of pixels that are based upon the image captured by a second camera.

17. A computer program product according to claim 15 wherein the program code instructions configured to generate the first panoramic view and the second panoramic view comprise program code instructions configured to generate, for the panoramic views, a third region of the respective panoramic view such that pixels within the third region are based upon an image captured by the one camera, wherein the second region is positioned between the first and third regions of the respective panoramic image.

18. A computer program product according to claim 15 wherein the computer-executable program code instructions further comprise program code instructions configured to cause the first and second panoramic views to be presented to left and right eyes, respectively, such that the first region of the respective panoramic views is presented in two dimensions and the second region of the respective panoramic views is presented in three dimensions.

19. A computer program product according to claim 15 wherein the program code instructions configured to combine the images captured by at least two of the cameras comprise program code instructions configured to combine the images captured by at least two of the cameras utilizing depth based blending.

20. A computer program product according to claim 15 wherein the at least three cameras comprise first, second and third cameras having different, but partially overlapping fields of view, and wherein the program code instructions configured to generate the second region of the respective panoramic view comprise program code instructions configured to generate the second region of the first panoramic view based upon a combination of the images captured by the first and second cameras and program code instructions configured to generate the second region of the second panoramic view based upon a combination of the images captured by the second and third cameras.
